(19) United States
(12) Patent Application Publication
(10) Pub. No.: US 2014/0272585 A1
(43) Pub. Date: Sep. 18, 2014

(54) Electrode for an electrochemical energy store

(71) Applicant: Ingo KERKAMM, Stuttgart-Rohr (DE)

(72) Inventor: Ingo KERKAMM, Stuttgart-Rohr (DE)

(73) Assignee: Robert Bosch GmbH, Stuttgart (DE)

(21) Appl. No.: 14/210,829

(22) Filed: Mar. 14, 2014

(30) Foreign Application Priority Data
Mar. 18, 2013 (DE) 10 2013 204 671.5

(51) Int. Cl. H01G 11/50; H01M 4/52; H01M 4/50; H01M 4/36; H01M 4/485

(52) U.S. Cl. CPC H01G 11/50; H01M 4/366; H01M 4/485; H01M 4/50; H01M 4/52
USPC 429/220; 429/218.1; 29/623.5; 429/231.95; 429/223; 429/231.5; 429/224; 429/221; 429/231.1; 429/231.3; 361/502

(57) ABSTRACT

An electrode for an electrochemical energy store, including an active material layer having an active material, a protective layer being at least partially applied to the active material, and the protective layer at least partially including a fluorophosphate-based material. Such an electrode offers a particularly high stability, even when high voltages are present. Also described is a method for manufacturing an electrode, to an electrochemical energy store and to the use of a fluorophosphate-based material for generating a protective layer for an active material of an electrode of an electrochemical energy store.

### RELATED APPLICATION INFORMATION

The present application claims priority to and the benefit of German patent application no. 10 2013 204 671.5, which was filed in Germany on Mar. 18, 2013, the disclosure of which is incorporated herein by reference.

### FIELD OF THE INVENTION

The present invention relates to an electrode for an electrochemical energy store and to a method for manufacturing such an electrode. The present invention further relates to the use of a fluorophosphate-based material for forming a protective layer for an active material of an electrode.

### BACKGROUND INFORMATION

Energy stores, such as lithium-ion batteries, are very common and at present are of particular interest both for mobile communication and for entertainment media. For example, such electrochemical energy stores are used in computers, such as laptops, mobile telephones, smart phones and other applications. Such batteries also offer advantages for the presently intensively promoted electrification of vehicles, such as motor vehicles.

In particular to make the above-mentioned applications possible, the energy stores should satisfy ever greater requirements. For example, endeavors are in progress to make energy stores safer, more cost-effective and more powerful. In general, a plurality of possible parameters exists for this purpose, so that an energy store is able to meet the desired requirements.

### SUMMARY OF THE INVENTION

The subject matter of the present invention is an electrode for an electrochemical energy store, including an active material layer having an active material, a protective layer being at least partially applied to the active material, and the protective layer at least partially including a fluorophosphate-based material.

### DETAILED DESCRIPTION

Within the sense of the present invention, an electrochemical energy store may be understood to mean, in particular, any battery. In addition to a primary battery, an energy store may in particular include above all a secondary battery, i.e., a rechargeable battery. A battery may include or be a galvanic element or multiple of mutually connected galvanic elements. For example, an energy store may include a lithium-based energy store, such as a lithium-ion battery. A lithium-based energy store, such as a lithium-ion battery, may be understood to mean in particular such an energy store whose electrochemical processes during a charging or discharging process are at least partially based on lithium ions. Moreover, an electrochemical energy store may be understood to mean additional electrical energy store systems which are based on electrochemical processes, such as supercapacitors.

An active material layer may be understood to mean a layer in which the active material is situated. Within the sense of the present invention, the active material may further be understood to mean a material which in particular is involved in a charging process or discharging process and which thus may constitute the active material per se. The active material may be an integral part of an electrode material which thus includes the active material, and thus may form the active material layer. In addition to the active material per se, a suitable conductive additive, such as graphite or carbon black, and a suitable binder, such as polyvinylidene fluoride (PVDF), may generally be situated in the electrode material.

Within the sense of the present invention, a protective layer may further be understood to mean a layer which covers the active material at least partially, i.e., at least in a locally delimited manner, or also completely, and is thus able to protect the same from external influences. For example, the protective layer may spatially separate the active material from an electrolyte, at least partially.

Within the sense of the present invention, a fluorophosphate-based material may further be a material which may be ionic and which may include the fluorophosphate anion (PO₄F⁴⁻) as the anion. The fluorophosphate-based material may include cationic components as further constituents, and in particular metal ions as cations, to obtain a neutral material. The fluorophosphate-based material, which hereafter is referred to as fluorophosphate material, may further entirely form the protective layer; the protective layer may thus be made of this material, or the protective layer may include the fluorophosphate material only partially in, in particular defined, locations.

An above-described electrode makes it possible in particular to provide a particularly high stability of the electrode material against external influences, while offering high performance capability of an energy store equipped with such an electrode.

In detail, the active material may initially be mechanically covered by the protective layer in an above-described electrode. The active material may thus be protected from mechanical damage and therefore have good stability against, or good protection from, external mechanical influences.

Moreover, fluorophosphate materials in particular form a material class which protects the active material, such as the surface of the active material, from negative side reactions, such as with the electrolyte. This may be implementable even with high voltages which are present during a charging process or a discharging process. In detail, the above-described material of the protective layer is also able to withstand voltages of up to 5 V or even above.

Depending on which cation is used, the fluorophosphate material may further be chemically inactive with respect to Li/Li+ regarding a lithium insertion and a lithium extraction, also up to high voltages, such as 5 V or above. The charging processes or discharging processes are thus not interfered with, but rather precisely defined electrochemical processes may take place, allowing a reduction of the performance capability of an electrochemical energy store equipped with such an electrode to be prevented.

Moreover, a fluorophosphate material offers the advantage that the electrochemical properties of the electrode material are improved. In detail, by applying a fluorophosphate protective layer, the electrical or ionic conductivity of the base material may be improved, for example, due to interfacial phenomena, resulting in improved rate capability of the overall material. Additionally, the structure of the base material may be stabilized in that, for example, the effect of the decrease of the mean average discharge voltage as a function of aging (“voltage fade”), as it is known from the high energy NCM material, is diminished.

Moreover, it is possible to achieve increased stability of the electrode against thermal influences since in particular thermal influences may result in the active material reacting, in particular on its surface, and being otherwise negatively influenced. For example, oxygen may be undesirably released from the active material, which negatively influences the properties of the active material and may further negatively affect the energy store due to gassing. This too is particularly effectively preventable by the above-described protective layer including a fluorophosphate material.

An above-described electrode, in particular using a protective layer based on a fluorophosphate material, is also able to effectively counteract, or even completely prevent, the occurrence of an irreversible capacity loss of the active material, as it may frequently occur when passing through a first cycle.

Thus there is the possibility with an above-described electrode to use a wide variety of electrode materials, or a wide variety of active materials, which allow particularly high energy densities, further allowing a particularly high stability of the energy store or of the electrodes. Furthermore, as a result of increased coulombic efficiency, the capacity as well as the energy density are able to remain stable up to a high number of cycles, such as in particular up to 3,000 cycles or more, so that the long term stability during normal use may be improved, regardless of concrete damage to the electrode.

Moreover, particularly advantageously a transport of lithium ions and electrons through the electrode material, such as in particular the cathode material, may be enabled, and thus the rate capability may be improved, whereby a particularly rapid charging process or discharging process may be made possible.

In summary, an above-described electrode may provide advantages with respect to the electrochemical properties of the electrodes and the thermal stability as well as the long term stability of the electrodes, such as in particular of the cathode. However, this also applies to the anode, since the protective layer on the active material of the cathode may also prevent, for example, nickel, cobalt and manganese, which may be manganese, from leaching and diffusing into the anode as well as depositing on the anode and damaging the solid electrolyte interface (SEI) of the anode. An above-described electrode is furthermore cost-effectively producible.

Within the scope of one embodiment, the fluorophosphate-based material of the protective layer may include a metal which is selected from the group composed of lithium (Li), nickel (Ni), cobalt (Co), iron (Fe), vanadium (V), copper (Cu), manganese (Mn) or a mixture of the aforementioned metals. The fluorophosphate-based material of the protective layer may in particular include a metal ion of one or multiple of the aforementioned metals, in particular to obtain an electrically neutral compound.

The protective layer may in particular at least partially include a material which is based on the compound LiₓPO₄F. Being based on the aforementioned structure may mean that x is selected to obtain an uncharged substance. Moreover, x may be selected to only partially compensate for the charge of the fluorophosphate anion, it being possible for additional cations, such as in particular metallic cations, to be present in order to obtain an uncharged material. In other words, it may be provided that x=1, 2, 3, 4. The protective layer may be made in particular of the aforementioned material, for example it may be made of this material.

For example, the protective layer may at least partially include a material which is based on the compound LiₓM_{y}PO₄F, M being selectable from the group composed of nickel (Ni), cobalt (Co), iron (Fe), vanadium (V), copper (Cu), and manganese (Mn). For this purpose, x and y furthermore are arbitrarily selectable and matchable to each other to obtain an uncharged material. In other words, x=0, 1, 2, 3, 4 and y=0, 1, 2, 3, 4 are possible. In particular, the protective layer may be formed of the aforementioned material, for example it may be made of this material.

The aforementioned materials, i.e., LiₓPO₄F and LiₓM_{y}PO₄F, may in particular be effectively suitable for reliably protecting the electrode material or the active material mechanically as well as from undesired side reactions, for increasing the electrical and ionic conductivity, for improving the structural phase stability as a function of aging, and furthermore for increasing the performance capability of an energy store equipped with such an electrode. In particular the embodiments which are based on cobalt, iron and nickel may be particularly advantageously suitable as the protective layer since their electrochemical redox potentials are at least in some cases above 5 V.

Within the scope of one further embodiment, the active material may be based on a nickel cobalt manganate (NCM). In this embodiment, the active material may thus be in particular a cathode material, and may in particular selectively and reversibly intercalate lithium ions. In particular a nickel cobalt manganate, also referred to as NCM, as the active material may be advantageously usable, for example, for applications requiring high power density in order to replace other active materials, such as LiCoO₂, and thus obtain a particularly cost-effective and safe active material, which additionally has a high capacity. In general, a nickel cobalt manganate may be understood to mean such a material which is based on the chemical formula Li(NiₓCo_{y}Mn_{1-x-y})O₂, where x=greater than or equal to 0.1 to smaller than or equal to 0.9, which may be 0.3, and y=greater than or equal to 0 to smaller than or equal to 0.8, which may be 0.3.

LiMn_{1/3}Ni_{1/3}Co_{1/3}O₂ may be mentioned as an NCM material purely by way of example, which as a result of an addition of further lithium and/or further manganese, and furthermore oxygen ions for charge compensation, may have areas which may include Li₂MnO₃, for example, which structurally may be integrated into the NCM material, which may also be referred to as “overlithiating.” In particular the aforementioned Li₂MnO₃-like areas may cause the active material structure to be stabilized and the discharge capacity to be improved to values of approximately 300 mAh/g in relation to the active material. Moreover, the release of the lithium may take place together with the release of oxygen, such as due to a loss of LiO₂, at high voltages of 4.6 V to 4.8 V.

In particular such high voltages, which may be advantageous for achieving the advantages of overlithiated NCM materials (HE-NCM) as active materials, may under normal circumstances lead to the fact that the electrolyte which is used undergoes undesirable side reactions with the active material, or that a capacity loss due to the above-described release of lithium and oxygen may occur. Effective protection is therefore advantageous in particular for the above-described overlithiated NCM materials, which is why an electrode may be of particular advantage, in particular in a combination of a protective layer having a fluorophosphate material on an electrode material with an overlithiated NCM material as the active material.

A high energy NCM (HE-NCM) material may thus be understood to mean in particular such a material which is based on an NCM material and, for example, has a composition of 0.5 Li₂MnO₃ x 0.5 Li(NiₓCo_{y}Mn_{1-x-y})O₂.

For example, the active material may be based on the chemical formula xLi₂MnO₃-(1-x)LiMO₂, M being selected from the group composed of cobalt (Co), nickel (Ni), manganese (Mn) and further elements, such as aluminum (Al), potassium (K), sodium (N) or alternatives, and x being greater than or equal to 0 to smaller than or equal to 1. Such active materials are able to provide a particularly good capacity and furthermore good stability.

With respect to additional advantages and features of the above-described electrode, reference is hereby explicitly made to the descriptions in connection with the energy store according to the present invention and the method according to the present invention. Features and advantages according to the present invention of the electrode according to the present invention shall also be applicable to, and be considered disclosed for, the method according to the present invention and the energy store according to the present invention, and vice versa. The present invention also covers all combinations of at least two features disclosed in the description and/or in the claims.

A subject matter of the present invention is furthermore an energy store, including at least one electrode configured as described above. Such an energy store may in particular have the advantages which are described with respect to the electrode. In summary, such an energy store may provide advantages with respect to the thermal stability as well as the long term stability of the electrodes, such as in particular of the cathodes, but also anodes, and furthermore with respect to the electrochemical properties of the electrodes. An above-described electrode, and thus an above-described energy store, is furthermore particularly cost-effective to manufacture.

Such an energy store is usable in many daily applications, for example. They are used in computers, such as laptops, mobile telephones, smart phones and other applications, for example. Such energy stores also offer advantages for the presently intensively promoted electrification of vehicles, such as motor vehicles or electric bicycles.

An above-described energy store may be a lithium-based energy store, such as a lithium-ion battery, for example, without limiting the present invention. Its anode and the cathode, or their active materials or electrode materials, may generally be based on materials which are known per se. For the purely exemplary case of a lithium-ion battery, the anode may be an electrode which includes metallic lithium or which is able to intercalate lithium, such as into graphite or silicon. The cathode may include or be based on NMC or lithium cobalt oxide (LiCoO₂), by way of example. If necessary, the cathode material may be present in a binder, such as polyvinylidene fluoride (PVDF), for example together with a conductive additive, such as an electrically conductive carbon compound, e.g., graphite. The electrolyte may include a solvent in which one or multiple electrically conductive salts is/are dissolved. For example, aprotic solvents, such as ethylene carbonate, propylene carbonate, dimethyl carbonate or diethyl carbonate, may be used. Moreover, lithium hexafluorophosphate (LiPF₆) may be used as an electrically conductive salt.

Moreover, a separator may be situated in the manner known per se between the anode and the cathode to spatially separate the anode and the cathode from each other, in particular in order to prevent a short circuit. For example, the separator may in particular include or be made of porous plastic films, glass fiber fabrics, or also in particular porous ceramic materials, such as ceramic fabrics. The electrolyte may be situated within the separator or pores of the separator, for example.

In addition to a conventional rechargeable lithium-ion battery, for example, the energy store may furthermore be a supercapacitor. Within the sense of the present invention, a supercapacitor in the manner known per se may be understood to mean in particular a capacitor whose capacitance value is composable from multiple influences, such as from a static Helmholtz double layer and, on the other hand, from an electrochemical or faradaic pseudo capacitance. With pseudo capacitance, the electrical energy may be stored as a function of the voltage electrochemically or with the aid of a faradaic redox reaction with a charge exchange at the electrodes. In the, in particular electrically insulating, Helmholtz double layer, the electrical energy may furthermore be stored statically on the surface of large-surface-area electrode materials as a double layer capacitance in electric fields. Accordingly, the supercapacitor may, for example, be composed of one anode, which may be configured as is known for a conventional battery, for example, one static capacitive electrode as the cathode, a separator situated between the anode and the cathode, and an electrolyte situated between the anode and the cathode, the electrodes including the above-described protective layer for the electrode material or active material.

For example, a lithium-ion capacitor in the form of a hybrid capacitor, which includes one electrode of a conventional double layer capacitor and one electrode which includes lithium, or may be doped with lithium, and which may be battery-like and thus have an electrochemical pseudo capacitance, may be provided as the supercapacitor, without limiting the present invention. The anode may include a described active material having a protective layer, for example. Moreover, the static capacitive electrode may include a carbon compound, in particular activated carbon, graphite, graphene, carbon nanofibers or carbon nanotubes. The separator may furthermore include an in particular porous plastic film, a glass fiber fabric, or also an in particular porous ceramic material, such as a ceramic fabric, while the electrolyte may be a solid electrolyte, for example, or also may include a solvent in which one or multiple electrically conductive salts is/are dissolved. For example, aprotic solvents may be used, such as ethylene carbonate, propylene carbonate, dimethyl carbonate, diethyl carbonate or 1,2-dimethoxyethane. Moreover, lithium hexafluorophosphate (LiPF₆) or triazolates may be used as the electrically conductive salt.

With respect to additional advantages and features of the above-described energy store, reference is hereby explicitly made to the descriptions in connection with the electrode according to the present invention and the method according to the present invention. Features and advantages according to the present invention of the energy store according to the present invention shall also be applicable to, and be considered disclosed for, the method according to the present invention and the electrode according to the present invention, and vice versa. The present invention also covers all combinations of at least two features disclosed in the description and/or in the claims.

A subject matter of the present invention is furthermore a method for manufacturing an electrode for an energy store, in particular an electrode configured as described above, including the method steps:
a) providing an active material;
b) if necessary, adding a conductive additive;
c) if necessary, adding a binder;
d) at least partially coating the active material with a protective layer, the protective layer at least partially including a fluorophosphate-based material, or a precursor of a fluorophosphate-based material;
e) combining a current collector with the generated mixture; and
f) if necessary, compressing the manufactured electrode.

Such a method may be used in particular to manufacture an electrode for an electrochemical energy store. This electrode may in particular have the advantages which are described with respect to the electrode. In summary, such an energy store may provide advantages with respect to the thermal stability as well as the long term stability of the electrodes, such as in particular of the cathodes, and furthermore with respect to the electrochemical properties of the electrodes. An above-described electrode is furthermore particularly cost-effectively producible.

With method step a), the method initially includes the provision of an active material layer having an active material. The active material may be an NMC material, for example, such as an HE-NMC material. Purely by way of example, and without limiting the present invention, the active material may include LiMn_{1/3}Ni_{1/3}Co_{1/3}O₂ as the NCM material. Regarding an HE-NMC material, by way of example the active material may be based on the chemical formula xLi₂MnO₃-(1-x)LiMO₂, M being selected from the group composed of cobalt (Co), nickel (Ni), manganese (Mn) and aluminum (Al), or other elements, which may be other metals or transition metals, as was already described above. The active material may already be present in an electrode material and may be present, such as together with the additional constituents, in the form of a layer, such as on a current conductor, or the active material may be present in pure form without further constituents of the electrode material, in particularly in the form of particles.

Purely by way of example, an HE-NMC material may be producible as is discussed, for example, in J. Kim et al. Synthesis of xLi₂MnO₃(1-x)LiMO₂ (M=Cr, Mn, Co, Ni) nanocomposites and their electrochemical properties, Materials Research Bulletin 45 (2010) 252-255. Without limiting the present invention, 0.4 Li₂MnO₃.0.6 LiMo₂ may be used as the active material. This may be producible in that lithium hydroxide, manganese acetate, nickel acetate, cobalt acetate and chromium acetate are appropriately weighed in and stirred into water, the precipitated solution being dried and quenched. This method corresponds to the so-called co-precipitation method. Other possible methods are the so-called molten salt method or sucrose combustion.

Additionally, according to method step b), a conductive additive may be added, which in particular is intended to improve the electrical and/or ionic conductivity. Such a conductive additive may in particular be a conductive additive which is known per se. By way of example and without limiting the present invention, carbon compounds, such as graphite or carbon black, may be used.

Moreover, according to method step c), which may be a binder may be added, such as polyvinylidene fluoride (PVDF) or a cellulose-based binder. This binder may be useful in particular for the mechanical contacting.

According to method step d), thereafter at least partial coating of the active material layer, or of the active material, with a protective layer takes place, the protective layer at least partially including a fluorophosphate-based material, or a precursor of a fluorophosphate-based material, the fluorophosphate-based material of the protective layer in particular including a metal which is selected from the group composed of lithium (Li), nickel (Ni), cobalt (Co), iron (Fe), vanadium (V), copper (Cu), manganese (Mn), or a mixture of the aforementioned metals. In detail, the protective layer may include a material based on LiₓPO₄F. For example, the protective layer may at least partially include a material which is based on LiₓM_{y}PO₄F, M being selectable from the group composed of nickel (Ni), cobalt (Co), iron (Fe), vanadium (V), copper (cu), and manganese (Mn). The coating material, or the fluorophosphate material, may further be generatable with the aid of a sol-gel process. For the purely exemplary case of using LiVPO₄F, a V2O5.nH2O hydrogel may initially be produced by an aqueous hydrogen peroxide solution being added to vanadium oxide (V₂O₅). Stoichiometric quantities of NH₄H₂PO₄, LiF and in particular an excess amount of activated carbon may, in turn, be added to this solution.

For coating purposes, the active material may be supplied to the process simultaneously with or subsequent to the NH₄H₂PO₄, LiF and activated carbon, and may thus act as an initial nucleus. The product thus deposits on the surface of the active material. Thereafter, the obtained product may be dried. The activated carbon that is still present may remain in the mixture, for example, and may serve as a conductive additive. This step, if necessary, may thus partially or completely replace method step b).

Thus, either an already completed layer of an electrode material may be at least partially coated with the protective layer, or the particles of the active material or the particles of the electrode are coated, the particles of the active material being coatable before these are combined with the further materials of the electrode material and processed to form a layer. In the first case, the coating method may be carried out in one step together with the generation of the active material particles.

According to method step e), in the manner known per se, the mixture generated in the preceding method steps may be brought in contact with a current collector. This may be implemented, for example, in the manner known per se by the active material mixture being applied to the current collector, such as a metallic foil, for example, such as applied by coating or doctoring.

Thereafter, it may be necessary or advantageous to compress the electrode manufactured in method step e) in accordance with method step f). This may be carried out by applying pressure, for example in a calender. For example, elevated temperatures may be used for this purpose, such as in a range greater than or equal to 120° C.

In particular subsequent to the compression, the structure thus obtained may also be sintered. This may take place, for example, after drying at elevated temperatures in a range of 800° C., for example. In the event of sintering with air or under an oxygen atmosphere, activated carbon which is still present and undesirable may be removed. In the event that the activated carbon is to be preserved, the sintering step may also be carried out at a low partial pressure of oxygen, such as with the aid of a graphite lining and nitrogen or argon atmosphere. The coating may thus be sintered without combustion of the carbon.

Within the scope of one embodiment, particles including active material, which are agglomerated prior to method step b), may be provided in method step a). For example, the agglomeration may take place in one step directly during the synthesis of the active material, for example during the co-precipitation of the particles in the reactor. This may be implementable by suitably setting the process parameters, such as the duration, pH value and concentration of the components. Spherical particles having a low porosity and a diameter in a range of greater than or equal to 2 μm to smaller than or equal to 15 μm may be manufactured. In this way, larger particles of the active material may be manufactured prior to coating in order to be able to achieve a higher compression during the manufacture of the electrode than with nanoparticulate material. This may result in a higher capacity per electrode volume in mAh/cm³ per electrode.

Within the scope of a further embodiment, the product generated in method step d) may be heated. In particular with the aid of heating, in method step d) an amorphous or non-amorphous or crystalline precursor of a fluorophosphate material may be used and converted into the fluorophosphate material with the aid of heating. Individual constituents of the coating, such as metal ions, may react with the active material or diffuse into the same, or also be exchanged, which may result in a structural change of the active material, for example, such as of the NMC or HE-NMC material. The heating is advantageous for creating or improving the structure of the coating. By way of example, suitable temperature values are between greater than or equal to 500° C. or smaller than or equal to 800° C., without limiting the present invention. A diffusion of the transition metals of the coating, such as vanadium or iron or nickel into the structure of the active material may take place in the process. This may leave the active material structure unaffected, however, it may result in a structure of the coating having no or a low content of transition metal ions.

With respect to additional advantages and features of the above-described energy store, reference is hereby explicitly made to the descriptions in connection with the electrode according to the present invention and the method according to the present invention. Features and advantages according to the present invention of the energy store according to the present invention shall also be applicable to, and be considered disclosed for, the method according to the present invention and the electrode according to the present invention, and vice versa. The present invention also covers all combinations of at least two features disclosed in the description and/or in the claims.

What is claimed is:

1. An electrode for an electrochemical energy store, comprising:
an active material layer having an active material, wherein a protective layer is at least partially applied to the active material, and the protective layer at least partially includes a fluorophosphate-based material.

2. The electrode of claim 1, wherein the fluorophosphate-based material of the protective layer includes a metal which is selected from the group composed of lithium, nickel, cobalt, iron, vanadium, copper, manganese or a mixture of the aforementioned metals.

3. The electrode of claim 2, wherein the fluorophosphate-based material of the protective layer is based on the compound LiₓPO₄F.

4. The electrode of claim 3, wherein the fluorophosphate-based material of the protective layer is based on the compound LiₓM_{y}PO₄F.

5. The electrode of claim 1, wherein the active material is based on a nickel cobalt manganate.

6. An energy store, comprising:
at least one electrode for an electrochemical energy store, including:
an active material layer having an active material, wherein a protective layer is at least partially applied to the active material, and the protective layer at least partially includes a fluorophosphate-based material.

7. A method for manufacturing an electrode for an energy store, the method comprising:
(a) providing an active material;
(b) if necessary, adding a conductive additive;
(c) if necessary, adding a binder;
(d) at least partially coating the active material with a protective layer, the protective layer at least partially including a fluorophosphate-based material, or a precursor of a fluorophosphate-based material;
(e) combining a current collector with the generated mixture; and
(f) if necessary, compressing the manufactured electrode.

8. The method of claim 7, wherein in (a), particles including active material are provided, which are agglomerated prior to performing (b).

9. The method of claim 7, wherein the product generated in (b) is heated.

10. The method of claim 7, wherein the energy store includes at least one electrode, which includes:
an active material layer having an active material, wherein a protective layer is at least partially applied to the active material, and the protective layer at least partially includes a fluorophosphate-based material.

11. A fluorophosphate-based material comprising:
a fluorophosphate-based material for generating a protective layer for an active material of an electrode of an electrochemical energy store;
wherein the electrode is for an electrochemical energy store, and includes:
an active material layer having an active material, wherein a protective layer is at least partially applied to the active material, and the protective layer at least partially includes a fluorophosphate-based material.
